(19) United States
(12) Patent Application Publication
(10) Pub. No.: US 2004/0148606 A1
(43) Pub. Date: Jul. 29, 2004

(54) Multi-thread computer

(75) Inventor: Koji Hosoe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/739,016

(22) Filed: Dec. 19, 2003

(30) Foreign Application Priority Data
Jan. 28, 2003 (JP) 2003-019246

(51) Int. Cl. G06F 9/46

(52) U.S. Cl. 718/100

(57) ABSTRACT

There is provided a thread specific resource for each of a plurality of threads. Each thread specific resource includes a program counter and a register set that are unalterably allotted to a specific thread. An executing unit transmits to a thread managing unit an execution request that specifies a thread. A plurality of modules also transmit to the thread managing unit similar execution requests. The thread managing unit queues and stores the threads specified by the execution requests. When a thread switching unit receives a switching request from the executing unit, the thread switching unit selects a thread from among the queued threads and feeds the thread specific resource of the selected thread to a decoder.

### BACKGROUND OF THE INVENTION

1) Field of the Invention

The present invention relates to a multi-thread computer in which a processor switches between multiple threads.

2) Description of the Related Art

In multi-thread computers processing takes place by switching between multiple threads to increase the efficiency of a processor. Such a multi-thread computer is provided with multiple program counters and register sets or register files, and each processor switches sequentially between program counters and register sets.

Provision of multiple program counters and register sets enables each thread to occupy the allotted program counter and register set until the completion of its task and thereby each thread is able to operate independently. Consequently, other processes can be carried out while awaiting a response during a high latency process such as a DMA transfer or communication control, and the like. Further, the waiting period in a processor can be shortened,-as the contents of the program counter and the register set are not affected while process switching.

In the conventional multi-thread computer, multiple processes that were managed by the operating system (OS) were carried out thread-wise. These processes in turn generated several child processes and the execution of the child processes is reflected on the original process. In other words, an overall efficient process was realized by the original process executing a predetermined task and generating child processes, which become extinct in a relatively .short time.

It is essential in such multi-thread computers that information between processes is carried over and the sequence of execution between processes is managed. In the multi-thread computers disclosed in Japanese Patent Laid-Open Publication No. 2000-207233 and Japanese Patent Laid-Open Publication No. H10-78880, for instance, the efficiency of such a carry over process which carries over information from an original process to the child process and back again has been described.

In the multi-thread computer disclosed in Japanese Patent Laid-Open Publication No. H2-254544, an order of priority is established amongst the threads. A thread that has a high priority is executed first. If thread switching takes place while the thread with the higher priority is underway, then a process with a low priority is carried out.

However, in the conventional multi-thread computer, considerable time elapses from when the threads are set up and the set up threads are allotted to register sets and program counters.

In other words, a thread at the time of its creation is allotted to a specific register set and program counter. This ensures that a different thread is allotted to each register set and program counter. Due to this, the versatility of the processes is enhanced. However, if a thread is repeatedly executed, shortening the time for making available the thread is preferable over improving the versatility of the process.

Particularly, in a processor such as an integral processor in which prescribed processes are repeatedly executed at a high frequency and each process is completed in a short period, making available the threads may tax the resources so as to reduce the overall processing speed.

Further, when processing an input from an external device, the order of priority cannot generally be established in the integral processor. As a result, management of threads by establishing the order of priority, as in the conventional method, is not possible.

### SUMMARY OF THE INVENTION

It is an object of the present invention to solve at least the problems in the conventional technology.

A multi-thread computer according to one aspect of the present invention includes a thread specific resource corresponding to each of a plurality of threads, the thread specific resource including a program counter and a register set that are unalterably allotted to a corresponding one the threads; a thread managing unit that, upon receiving an execution request that specifies a thread from among the threads, queues the thread specified by the execution request; and a thread switching unit that selects a thread from among the threads that have been queued by the thread managing unit; and an executing unit that carries out execution of the thread selected by the thread selecting unit.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic diagram illustrating the structure of a microcontroller according to an embodiment of the present invention;

FIG. 2 is a drawing illustrating the management of threads in the microcontroller shown in FIG. 1;

FIG. 3 is a drawing illustrating a thread specific resource that has multiple program counters;

FIG. 4 is a drawing illustrating the process in the case in which a thread specific resource has multiple program counters;

FIG. 5 is a drawing illustrating addition of conditions to a thread execution request;

FIG. 6 is a drawing illustrating a thread managing unit in which a condition table is provided;

FIG. 7 is a drawing illustrating a structure in which a program counter for execution status storage can be changed; and

FIG. 8 is a drawing illustrating a structure of a thread managing unit in which an order of priority is established among the threads.

### DETAILED DESCRIPTION

Exemplary embodiments of a multi-thread computer according to the present invention will be explained next with reference to the accompanying drawings.

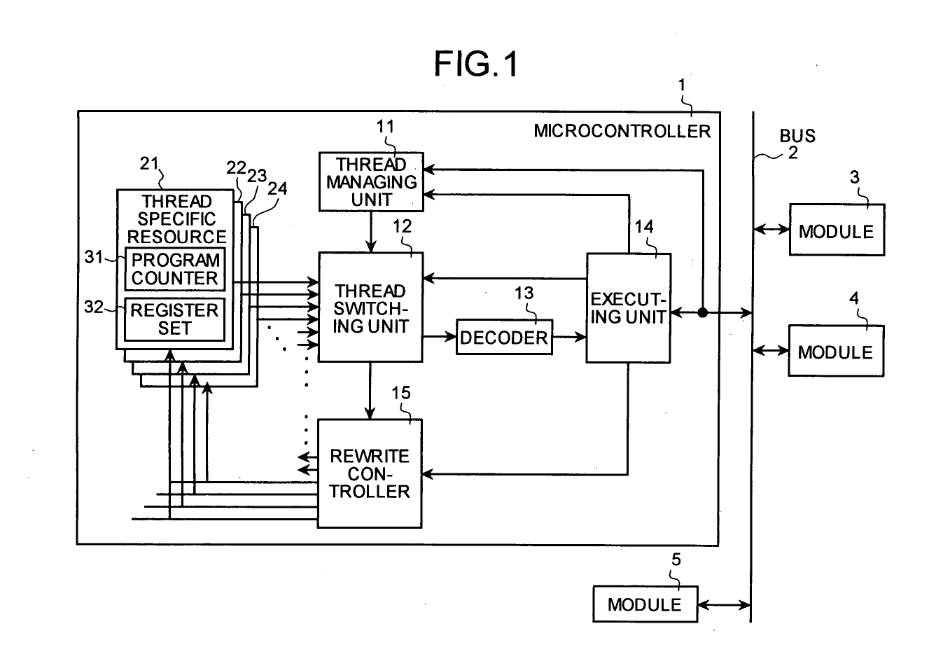

FIG. 1 is a schematic diagram of a microcontroller 1, which is a multi-thread computer according to an embodiment of the present invention. The microcontroller 1 is connected to three modules, 3 through 5, via a bus 2. The microcontroller 1 includes a thread managing unit 11, a thread switching unit 12, a decoder 13, an executing unit 14, a rewrite controller 15, and four thread specific resources, 21 through 24. The microcontroller 1 also includes other thread specific resources, however, those thread specific resources have not been shown in FIG. 1 for the sake of convenience.

The thread specific resource 21 includes a program counter 31 and a register set 32. Similarly, the remaining thread specific resources 22 through 24 and the not shown thread specific resources respectively include program counters and register sets.

The thread specific resources 21 through 24 and the other not shown thread specific resources are pre-allotted unalterably to specific threads. Therefore, a thread that executes a certain process always uses the thread specific resource which is allotted to it. Hence, the thread specific resource to be accessed is determined by the thread that is specified. Conversely, if the thread specific resource can be specified, then it can be determined to which thread the contents stored in the thread specific resource pertains.

Upon receiving a thread execution request via the bus 2 from the modules 3 through 5, or upon output of the thread execution request by the executing unit 14 as a result of a process, the thread managing unit 11 stores the thread for which execution is requested by queuing it. If subsequently, the executing unit 14 outputs a request for switching of threads, the thread switching unit 12 selects the thread that is next to the one that is queued by the thread managing unit 11, and switches to the thread specific resource corresponding to the selected thread. The decoder 13 decodes the instruction with the help of the program counter and the register set of the thread specific resource selected by the thread switching unit 12 and transmits the decoded instruction to the executing unit 14.

The result obtained by executing the instruction (hereinafter, “execution result”) by the executing unit 14 reflects in the thread specific resource through the rewrite controller 15. The rewrite control takes place according to the thread switching by the thread switching unit 12. If the execution result obtained by the executing unit 14 necessitates execution of a new thread, the executing unit 14 transmits to the thread managing unit 11 a thread execution request by specifying the thread which is to be executed. If on the other hand the execution result obtained by the executing unit 14 necessitates switching of threads, the executing unit 14 transmits to the thread switching unit 12 a thread switching request.

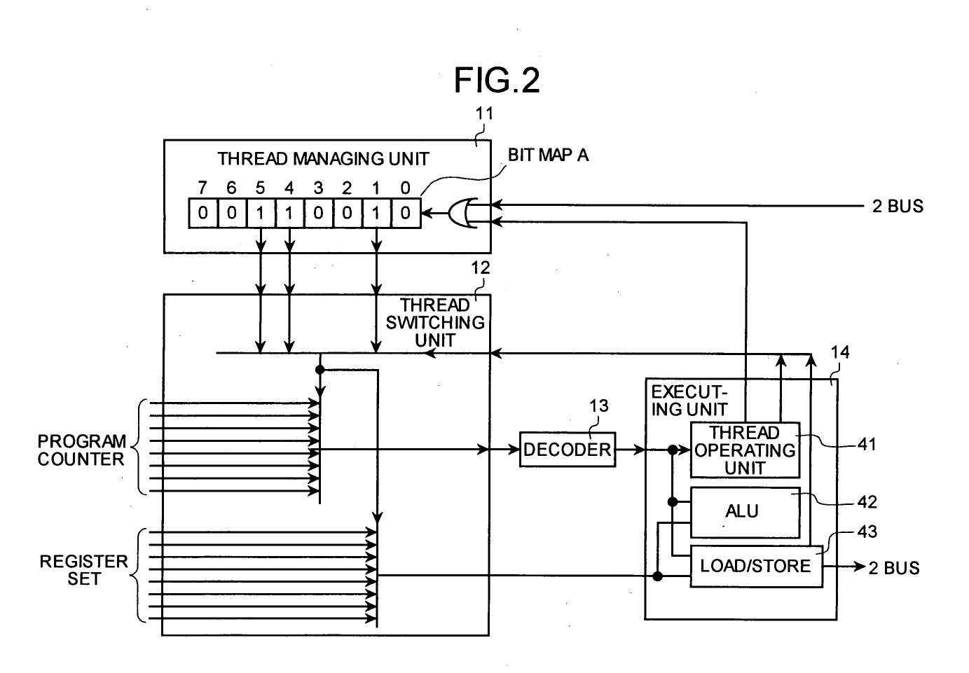

The management of threads in the microcontroller will be explained in further detail with reference to FIG. 2. The thread managing unit 11 includes a bit map A. The bit map A has information about each thread in the form of one bit and stores information related to whether the thread is queued or not. The bit map A has as many bits as the number of threads, that is, eight. If a thread is selected for execution request, the value of the bit corresponding to the thread changes to ‘1’.

Upon receiving a thread switching request, the thread switching unit 12 selects, from amongst the threads having the value “1”, the next thread, and feeds, respectively to the decoder 13 and the executing unit 14, the program counter value and the register set value corresponding to the selected thread. The thread managing unit 11, changes the value of the bit corresponding to the selected thread to ‘0’

The executing unit 14 internally includes a thread operating unit 41, an arithmetic logic unit (ALU) 42, and a load/store 43. The thread operating unit 41 outputs a thread execution request or a thread switching request, based on the output of the decoder 13. The arithmetic logic unit 42 carries out logical calculations based on the register set value. The load/store 43 outputs the thread switching request when there is a delay in the response to the communication.

The assessment of whether there is a delay in the response may be determined according to the destination of communication. Alternatively, if a predetermined period elapses without response, it may be taken as a cue for the output of the thread switching request. However, in the case in which a specific memory area is accessed above a feasible number of times by different threads, the load/store 43 does not output a thread switching request even though there is a delay in the response to the communication, and waits until a response is received.

The thread switching request output by the thread operating unit 41 and the load/store 43 may be in the form of an independent command or may be attached to a regular instruction as a bit information.

Thus, by allotting a specific program counter and a register set to each thread, thread switching can be realized without resorting to the use of the threads meant for the operating system or for management. Besides, the time required for making available a thread can be cut down. Making each thread specific for a program counter and register set enables a thread execution request from outside, represented by the modules 3 through 5 and the like, to be received directly. The logical sum of the execution request from the executing unit 14 and the execution request that is transmitted through the bus 2 is stored in the bit map A of the thread managing unit 11.

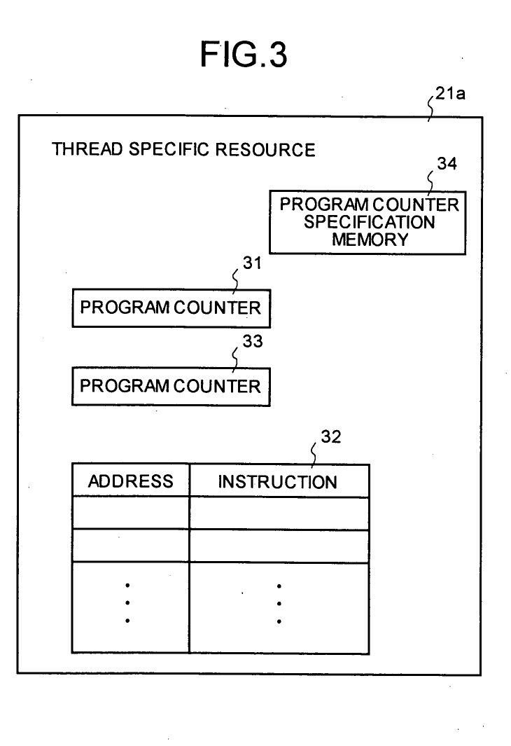

Any number of program counters can be provided in the thread specific resource. A thread specific resource having multiple program counters is illustrated in FIG. 3.

A thread specific resource 21a illustrated in FIG. 3 includes, apart from the program counter 31 and the register set 32, a program counter 33 and a program counter specification memory 34. The program counter 31 is employed while a thread is executed and is appended or overwritten, depending on the program being run, as in a regular computer system. On the other hand, the program counter 33 retains the value set by the thread operating unit 41. The program counter specification memory 34 is a memory which stores the information relating to whether the value of the program counter 31 is to be used or the value of the program counter 33 is to be used.

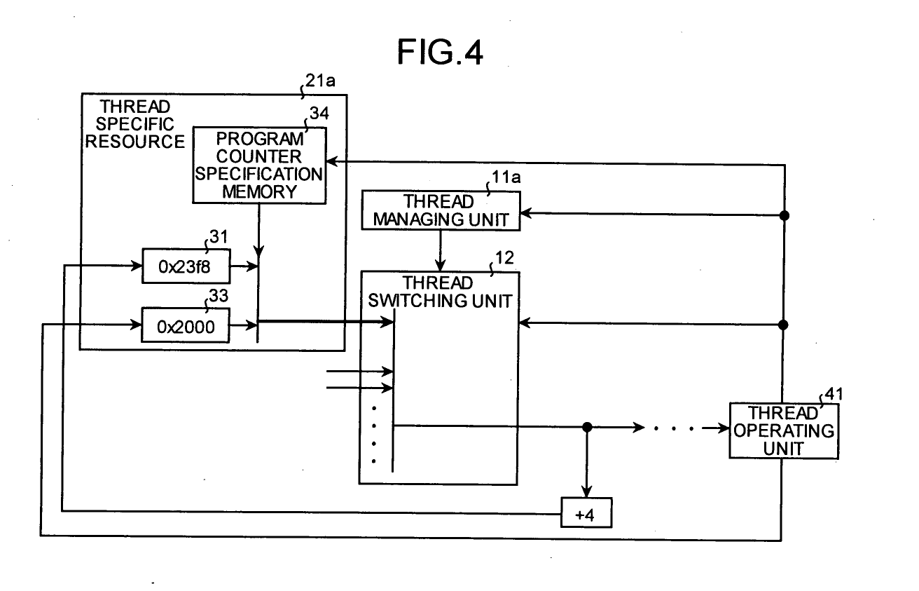

The process in the case in which a thread specific resource has multiple program counters will be explained next with reference to FIG. 4. When there are multiple program counters as shown in FIG. 4, the thread operating unit 41 determines whether to resume operation from the address indicated by the program counter 31 or from the address indicated by the program counter 33 when the next thread is to be run, and stores this information in the program counter specification memory 34.

When the next thread is to be run, the thread specific resource 21a feeds to the thread switching unit 12 either the value of the program counter 31 or the value of the program counter 33, according to the specification of the program counter specification memory 34. Consequently, the thread switching unit 12 does not deem it necessary to change the action pertaining to the number of program counters that the thread specific resource has.

The program counter 31 increments by a specific number in concurrence with the running of a program. The number that is added varies with the size of the command, being “2” for a 16-bit command, “4” for a 16-bit command, and “8” for a 64-bit command. On the other hand, the program counter 33 is updated by the thread operating unit 41 only when a specific command is executed. Thus, while the program counter 31 indicates the status of execution of a command, the program counter 33 indicates the starting position of the program specified by a command. If a process is executed by means of the program counter 33, the value obtained after increment of the value of the program counter 33 by a predetermined number is written to the program counter 31, and when the process is continued, the program counter 31 is used.

Thus, provision of multiple program counters allows, for instance, the program counter 31 to be used for continuously executing the same thread. Meanwhile the program counter 33 can be used to either execute a different thread or can be used to execute a thread with differing conditions, such as a thread that is used when an execution request is received from a module.

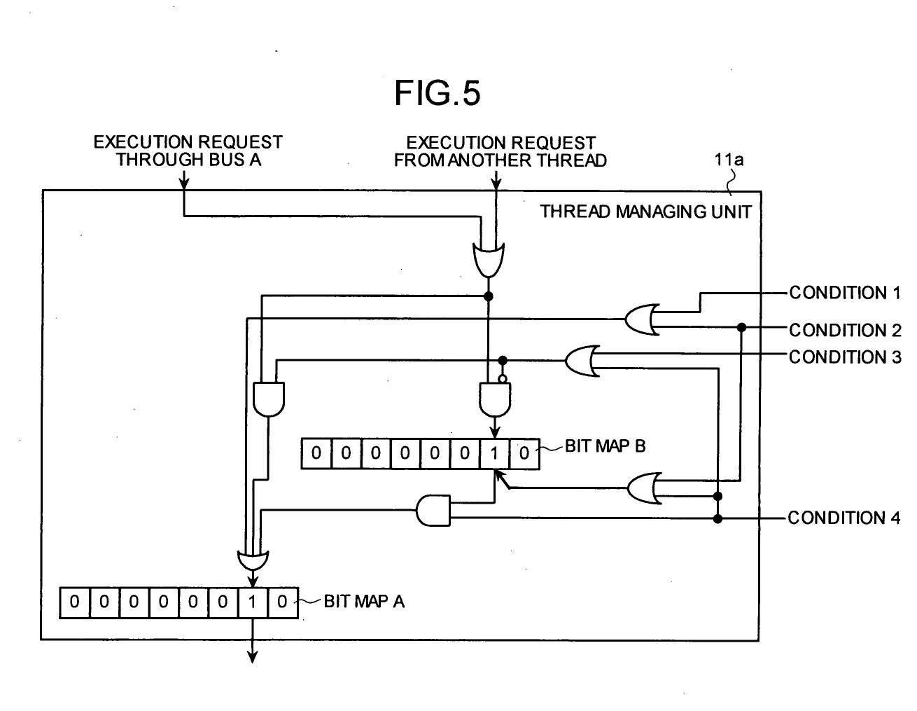

A thread managing unit 11a is provided with a bit map B, as shown in FIG. 5, in order to categorize the conditions of the thread execution request. The thread operating unit 41 sets the conditions and in FIG. 5, conditions 1 through 4 are as follows:

Condition 1: Queue the thread that is specified and execute from the program counter 31.

Condition 2: Queue the thread that is specified, and execute from the program counter 33.

Condition 3: Queue the thread if there is an execution request of another thread or an execution request via the bus 2, and use the program counter 31.

Condition 4: Queue the thread if there is an execution request of another thread or an execution request via the bus 2, and use the program counter 33.

When a thread is entered in the bit map A or when a thread execution request is received from another thread or from the modules 3 through 5, the thread managing unit 11a stores this execution request in the bit map B. Similar to bit map A, the bit map B has information about each thread in the form of one bit. The bit map B has as many bits as the number of threads and is shown to have an 8-bit memory.

Upon receiving an execution request in which condition 1 is set, the thread managing unit 11a immediately enters the thread in the bit map A and neither refers to nor makes any entry in the bit map B. Upon receiving an execution request in which condition 2 is set, the thread managing unit 11a immediately enters the thread in the bit map A as well as refers to the bit map B, and if the execution request is entered in the bit map B, removes the entry.

Upon receiving an execution request in which condition 3 is set, the thread managing unit 11a defers making any entry until an execution request is received from another thread or the modules 3 through 5. Once the execution request is received from another thread or the modules 3 through 5, the thread managing unit 11a enters it in the bit map A. In this case, the thread managing unit 11a neither refers to nor makes any entry in the bit map B.

Upon receiving an execution request in which condition 4 is set, the thread managing unit 11a defers making any entry until an execution request is received from another thread or the modules 3 through 5. Once the execution request is received from another thread or the modules 3 through 5, the thread managing unit 11a enters it in the bit map A. In addition, the thread managing unit 11a refers to the bit map B, and if the execution request is entered in the bit map B, removes the entry.

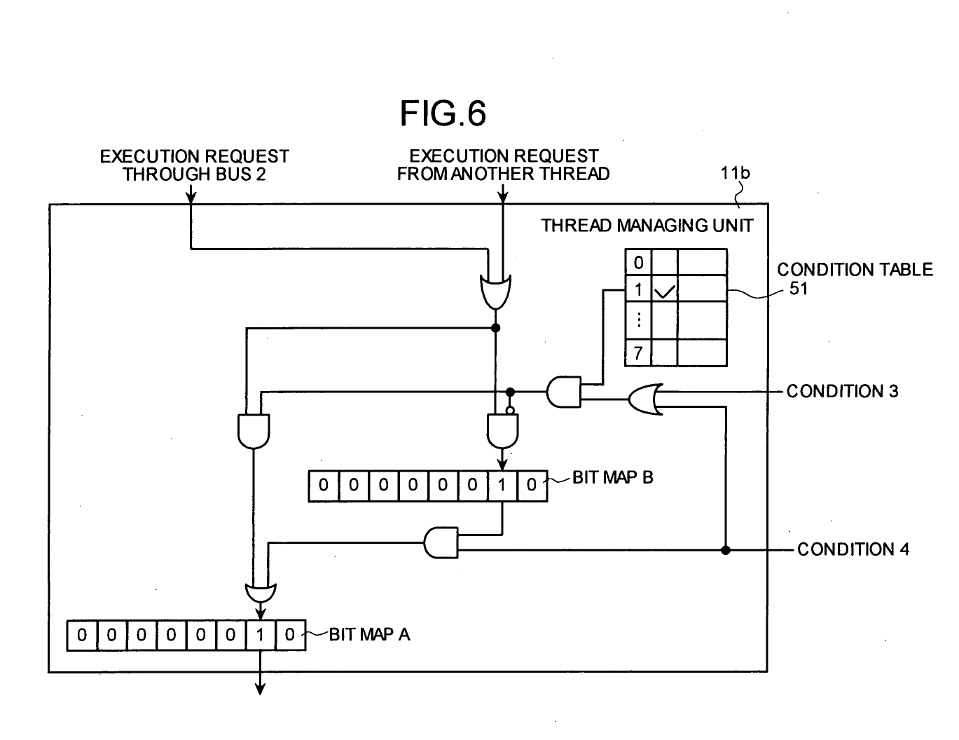

The more refined conditions can be set if a condition table is provided in the thread managing unit. FIG. 6 illustrates a thread managing unit 11b in which a condition table is provided. The managing unit 11b is provided with a condition table 51. The left column of the condition table 51 contains the thread numbers, the middle column contains the information relating to whether the condition is satisfied or not, and the right column contains the description of the condition.

Upon receiving an execution request in which either condition 3 or condition 4 is set, the thread managing unit 11b refers to the condition table 51. If the condition specified in the condition table 51 is met, the thread managing unit 11b makes an entry in the bit map A. If the condition specified in the condition table 51 is not met, the thread managing unit 11b makes an entry in the bit map B. In other respects, the thread managing unit 11b has the same structure and function as the thread managing unit 11a shown in FIG. 5. Hence, the explanation is omitted here.

The contents of the conditions set by the condition table 51 can for instance be used in an execution request from a specific module. The contents of the condition is changed by the entry made by the thread operating unit 41.

Thus, a condition can be set for thread execution by providing multiple bit maps in the thread managing unit. Further, a thread from a register set that satisfies the condition can be executed by providing multiple program counters in the thread specific resource. In addition, a condition can be further refined by providing a condition table in the thread managing unit.

In FIG. 4, the address which corresponds to program execution is permanently set in the program counter 31, and only the address of the program counter 33 is changed by the thread operating unit 41. However, it may also be possible to enable the thread operating unit 41 to change the address stored in the program counter that stores the execution status.

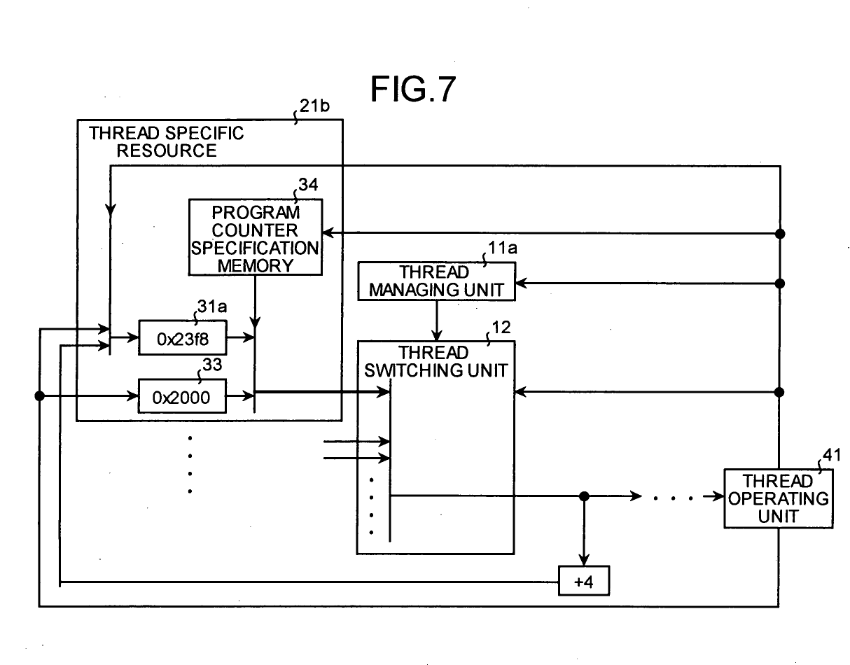

FIG. 7 illustrates a structure in which the program counter for execution status storage is changeable. In FIG. 7, a thread specific resource 21b includes a program counter 31a for storing the execution status of a program. The thread operating unit 41 can directly rewrite the value of the program counter 21b. In other respects, the structure and function are the same as in FIG. 4. Hence, same reference numerals are used and their explanation is omitted.

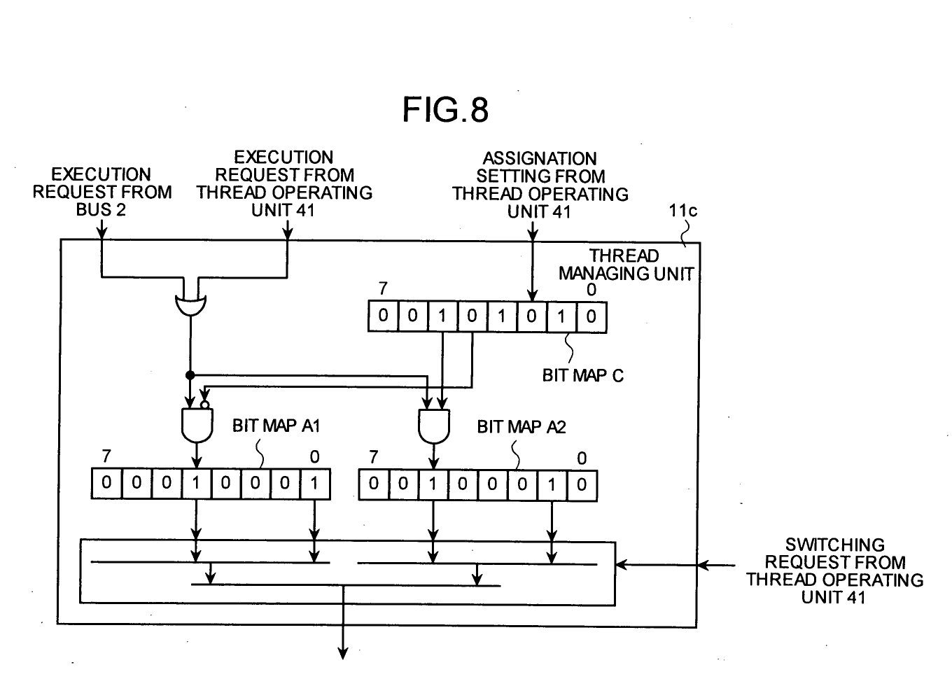

The setting of an order of priority for the execution of threads will be explained next. In the thread managing units 11, 11a, and 11b, no order of priority was set among the threads and the thread queuing was carried out by a single bit map A. FIG. 8 illustrates a structure of the thread managing unit which has a provision for setting an order of priority among the threads.

In FIG. 8, a thread managing unit 11c includes bit maps A1 and A2, and additionally a bit map C. The bit maps A1 and A2 function as storage areas in which the queue status of the threads is entered. Whereas the bit map A of the thread managing unit 11, 11a, and 11b stores the queue status pertaining to all the threads, the bit maps A1 and A2 have the entries of only the threads they are respectively responsible for.

The threads that the bit map A1 and A2 are responsible for are allotted by the bit map C. The queue status of the thread whose value is ‘0’ in the bit map C is allotted to the bit map A1, and the queue status of the thread whose value is ‘1’ in the bit map C is allotted to the bit map A2.

To be more specific, in the bit map C, the value of the threads 0, 2, 4, 6, and 7 is ‘0’, and the value of the threads 1, 3, and 5 is ‘1’. Consequently, the queue status of the threads 0, 2, 4, 6, and 7 are entered in the bit map A1, and the queue status of the threads 1, 3, and 5 are entered in the bit map A2. The value in the bit map C can be set randomly by the thread operating unit 41.

Upon receiving a switching request from the thread operating unit 41, the thread managing unit 11c selects one thread each from the bit map A1 and the bit map A2, and alternately executes the two selected threads. If no thread is entered in one of the bit maps, the thread managing unit 11c selects two threads successively from the same bit map.

Thus, because of such a configuration, the order of execution among the threads, that is, the probability of execution of the queued threads, can be regulated by providing a weight. The amount of weight can be adjusted by the setting of the bit map C.

If a specific thread is preferred for execution over another thread, it may be set such that thread entered in one of the bit maps is always preferably selected over the other bit map. For instance, it may be set such that as long as there are queued threads in the bit map A1, only the threads from the bit map A1 is selected, irrespective of the entry status in the bit map A2, and only when there are no threads for selection in bit map A1, the thread entered in the bit map A2 is selected. By doing so, an order of priority can be established among the threads.

To sum up, according to the present embodiment, specific program counters and register sets are pre-allotted to specific threads, and the thread specific resources are executed by switching between them. Consequently, thread switching can be realized without resorting to the use of the threads meant for the operating system or for management. Besides, the time required for making available a thread can be cut down. As a result, switching process is carried out efficiently, thereby enhancing the processing speed.

Further, making each thread specific for a program counter and register set enables a thread execution request from outside to be received and executed directly. The execution contents of a thread can be set by allotting multiple program counters for the thread, or by setting conditions for execution of the thread.

Further, the order of priority for the execution of threads can be managed by apportioning the threads between bit maps in which the queue status of the threads are entered.

In the multi-thread computer according to the present invention, each thread is unalterably pre-allotted a specific program counter and register set. A thread for which an execution request is received is queued and stored. If there is a switching request, the thread to be next executed is selected from the queued thread, and the contents of the thread specific resource corresponding to the selected thread is supplied to the executing unit. Thus, a multi-thread computer is realized in which the processes required for making available a thread can be cut down, the threads are managed efficiently, and the processing speed is enhanced.

In the multi-thread computer according to the present invention, if an execution request that specifies another thread is output as an execution result of one thread, the specified thread is queued and is selected as the thread to be executed next. Thus, a multi-thread computer is realized in which, along with an enhanced processing speed, an efficient management of threads is achieved by incorporating generation of new threads.

A multi-thread computer is realized in which, in addition to efficient thread management and enhanced processing speed, a thread from outside can be directly accepted for execution.

A multi-thread computer is realized in which, along with an enhanced processing speed, an efficient thread management is achieved by switching threads by selecting the thread to be executed next from a queued thread without resorting to using the threads meant for the operating system or for management.

In the multi-thread computer according to the present invention, when a process resulting from the execution of a thread fails to be completed within a fixed period, thread switching takes place. Thus, a multi-thread computer is realized in which, along with an enhanced processing speed, an efficient thread management is achieved by switching threads by selecting the thread to be executed next from a queued thread without resorting to using the threads meant for the operating system or for management.

In the multi-thread computer according to the present invention, when a process resulting from the execution of a thread fails to be completed within a fixed period, based on the content of the process, it is assessed whether to switch threads or not. Thus, a multi-thread computer is realized in which, along with an enhanced processing speed, an efficient thread management is achieved by switching threads by selecting the thread to be executed next from a queued thread without resorting to using the threads meant for the operating system or for management.

In the multi-thread computer according to the present invention, multiple program counters are associated with each thread, and the start position of a thread is specified by specifying the program counter that is to be used during execution. Thus, a multi-thread computer is realized in which, along with an enhanced processing speed, an efficient thread management is achieved by selecting the starting position of a thread.

In the multi-thread computer according to the present invention, a first program counter in which the value changes in accordance with the execution status of a thread, and a second program counter in which the value is independent of the execution status of the thread are provided. By selecting either the first program counter or the second program counter, it can be selected whether the threads are to be successively executed or are to be executed from a specified condition. Thus, a multi-thread computer is realized in which, along with an enhanced processing speed, an efficient thread management is achieved by selecting whether the threads are to be executed successively or from a specific starting position.

In the multi-thread computer according to the present invention, a starting condition of a thread can be set by rewriting the value of the first program counter and/or the value of the second program counter. Thus, a multi-thread computer is realized in which, along with an enhanced processing speed, an efficient thread management is achieved by changing the starting position of the thread.

In the multi-thread computer according to the present invention, a received execution request can be immediately queued or queued upon receiving an execution request from another thread or from outside. Thus, a multi-thread computer is realized in which, along with an enhanced processing speed, an efficient thread management is achieved by setting the condition for starting the execution of a thread.

In the multi-thread computer according to the present invention, a condition for queuing a thread is stored in a condition setting unit, and the thread is queued only when the condition is satisfied. Thus, a multi-thread computer is realized in which, along with an enhanced processing speed, an efficient thread management is achieved by minutely setting conditions for execution of the thread.

In the multi-thread computer according to the present invention, for each thread, a storage unit from among plural storage units is set for entering the execution status. During thread switching, one of the storage units is selected, and thereby the thread stored in the selected storage unit is selected as the thread to be executed. Thus, a multi-thread computer is realized in which, along with an enhanced processing speed, an efficient thread management is achieved by allocating priority in the order of execution of the threads.

In the multi-thread computer according to the present invention, for each thread, a storage unit from among plural storage units, among which an order of priority is established, is set for entering the execution status. During thread switching, the storage unit that has the high priority is selected, and thereby the thread stored in the selected storage unit is selected as the thread to be executed. Thus, a multi-thread computer is realized in which, along with an enhanced processing speed, an efficient thread management is achieved by allocating priority in the order of execution of the threads.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A multi-thread computer comprising:
a thread specific resource corresponding to each of a plurality of threads, the thread specific resource including a program counter and a register set that are unalterably allotted to a corresponding one the threads;
a thread managing unit that, upon receiving an execution request that specifies a thread from among the threads, queues the thread specified by the execution request; and
a thread switching unit that selects a thread from among the threads that have been queued by the thread managing unit; and
an executing unit that carries out execution of the thread selected by the thread selecting unit.

2. The multi-thread computer according to claim 1, wherein the executing unit outputs the execution request that specifies the thread as a result of execution of a current thread.

3. The multi-thread computer according to claim 1, wherein the execution request that specifies the thread is received from outside.

4. The multi-thread computer according to claim 1, wherein the executing unit outputs a switching request for switching to a different thread as a result of execution of a current thread, and the thread switching unit selects a different thread from among the threads that have been queued by the thread managing unit.

5. The multi-thread computer according to claim 1, wherein if the thread being executed by the executing unit includes a time-taking instruction that takes longer execution time than a predetermined time, the thread switching unit selects a different thread from among the threads that have been queued by the thread managing unit.

6. The multi-thread computer according to claim 5, wherein if there is the time-taking instruction, the executing unit assesses, based on contents of the time-taking instruction, whether to switch to a different thread, and if the executing unit deems it necessary to switch to a different thread, the thread switching unit selects a different thread from among the threads that have been queued by the thread managing unit.

7. The multi-thread computer according to claim 1, wherein each of the thread specific resources includes a plurality of program counters and a program counter specification memory that specifies the program counter that is to be used during execution of a thread.

8. The multi-thread computer according to claim 7, wherein the program counters include a first program counter whose value changes with status of execution of a thread, and a second program counter whose value is independent of the status of execution of a thread.

9. The multi-thread computer according to claim 8, wherein the executing unit rewrites the values of either of the first program counter and the second program counter, or both.

10. The multi-thread computer according to claim 1, wherein the thread managing unit performs either of based on a contents of the execution request
immediately queuing the thread specified by the execution request, and
queuing the thread upon receiving an execution request from another thread or from outside.

11. The multi-thread computer according to claim 10, wherein the thread managing unit includes a condition storing unit which stores a condition that indicates whether to queue the thread specified by the execution request.

12. The multi-thread computer according to claim 1, wherein the thread managing unit includes a storage unit for storing a queue status of the corresponding one of the threads, and
when selecting a thread, the thread switching unit selects the storage unit corresponding to the thread that is to be selected.

13. The multi-thread computer according to claim 12, wherein when selecting a storage unit, the thread managing unit selects the storage unit in accordance with a predetermined order of priority.
